(19) United States
(12) Patent Application Publication
(10) Pub. No.: US 2005/0073277 A1
(43) Pub. Date: Apr. 7, 2005

(54) Motor control system and method fast-adaptable to operation environment

(75) Inventor: Hyoung-il Kim, Gyeonggi-do (KR)

Correspondence Address: STAAS & HALSEY LLP, SUITE 700, 1201 NEW YORK AVENUE, N.W., WASHINGTON, DC, 20005, US

(73) Assignee: Samsung Electronics Co., Ltd., Suwon-City (KR)

(21) Appl. No.: 10/608,184

(22) Filed: Jun. 30, 2003

(30) Foreign Application Priority Data
Jun. 29, 2002 (KR) 2002-37516

(51) Int. Cl. G05B 11/42

(52) U.S. Cl. 318/610

(57) ABSTRACT

A method and an apparatus to control a motor includes calculating N control algorithms for respective controllers to correspond to N motor driving conditions, driving the motor under N motor driving environments by using at least one controller of the respective controllers, calculating performance indexes by using predetermined control factors which are detected when driving the motor using the at least one controller under the N motor driving environments, and storing the calculated N control algorithms for the respective controllers and the performance indexes corresponding to each of the N driving conditions. Accordingly, a motor driving controller optimum for driving environments is efficiently selected in a short time without wasting system resources.

### CROSS-REFERENCE TO RELATED APPLICATION

This application claims the priority of Korean Patent Application No. 2002-37516, filed Jun. 29, 2002 in the Korean Intellectual Property Office, which is incorporated herein by reference.

### BACKGROUND OF THE INVENTION

1. Field of the Invention

The present invention relates to a method of controlling a motor, and more particularly, to a motor control system and a method fast-adaptable to an operation environment to control a motor in a particular environment with control factors which are designed to consider an environment and operation characteristics of a system using the motor.

2. Description of the Related Art

FIG. 1 is a block diagram illustrating a conventional motor control system. Referring to FIG. 1, a motor control system includes a control unit 100, a plant 110, and a sensor unit 120. The control unit 100 includes an algorithm of a motor driving type and outputs a signal to drive a motor according to the algorithm. The plant 110 is a target to be controlled and includes the motor. The sensor unit 120 detects an operation state of the motor or an error of the motor when the motor is driven in the plant 110. A detection result is fed back to the control unit 100 and reflected in the control algorithm of the control unit 100 to improve the driving of the motor.

FIG. 2 is a flowchart of a conventional motor control algorithm. Referring to FIG. 2, a control resource and mechanism are analyzed in operation 200. Here, the control resource is analyzed by detecting information on a performance of a CPU which manages the control algorithm (for example, a clock frequency of the CPU), or by detecting a motor voltage applying type (for example, a PWM type). The control mechanism of the motor (for example, in a printer system), may be analyzed by detecting environmental and operation factors, such as friction force between a feed-roller rotated by the motor and a paper, inertia of the feed-roller, a motor torque, and a motor inertia. The analysis of the control resource and mechanism may be referred to as the analysis of a hardware environment required to accomplish a control specification.

When the analysis of the control resource and mechanism is completed, a controller is designed in operation 210. For example, in the case of a PID controller, constants of Kp, Ki, and Kd are determined in the controller to have a transfer function of Kp+Ki/s+Kd*s, and the constants are applied to the PID controller. Here, processes are programmed as a firmware and performed in a processor such as a CPU.

When the controller is designed, the motor is driven according to specification of the controller to operate a system, in operation 220.

In the case of using the motor control system of FIG. 2, performance of the system may be maintained only when environments given to design the motor controller are unchanged, (that is, factors that affect the design of the controller such as loads are not changed from factors during the initial design of the controller). If the factors are changed, the performance of the system, i.e., a motor driving performance, is lowered because the controller cannot reflect the changed factors.

FIG. 3 is a flowchart of another conventional motor control algorithm. Referring to FIG. 3, a control resource and mechanism are analyzed in operation 300.

When the control resource and mechanism are analyzed, controllers are designed and applied in operation 310. Here, a plurality of controllers are designed taking into account changes in loads. For example, in the case of using PID controllers, constants of Kp, Ki, and Kd are determined in the controllers to have a transfer function of Kp+Ki/s+Kd*s. The constants are Kp, Ki, and Kd applied to the PID controllers.

When the control constants used in the controllers are determined, a motor is driven according to the controllers in order to operate a system in operation 320.

Then, one of the plurality of controllers which generates the best motor driving result or system operation result, is selected and the system is controlled using the selected controller in operation 330.

The motor control system of FIG. 3 to overcome disadvantages of the motor control system of FIG. 2, designs the controllers taking into consideration changing factors of an environment, and operates the controllers to select the optimum controller which generates the best result, thereby controlling the system using the selected controller. Here, the performance of the controller is determined based on speed and acceleration of the motor which are detected by a sensor.

The conventional motor control method of FIG. 2 may be properly operated when the environment or the load conditions are not changed from the conditions of the initial design of the controller. However, if the environment or the load conditions of the system change, the controller cannot adapt to the changes. In the control method of FIG. 3, the controllers, which are designed according to each environment and load condition, are operated and the optimum controller of the controllers is selected. Thus, a process of detecting the optimum controller requires a large amount of time and only the speed and the acceleration of the motor are used to detect the optimum controller, making it difficult to reflect various environmental factors.

### SUMMARY OF THE INVENTION

Accordingly, it is an aspect of the present invention to provide a method and an apparatus to drive a motor to select and apply a motor driving controller optimum for an operation environment while not wasting system resources.

Additional aspects and advantages of the invention will be set forth in part in the description which follows and, in part, will be obvious from the description, or may be learned by practice of the invention.

The foregoing and/or other aspects of the present invention are achieved by providing a method of controlling a motor in a motor driving system. The method includes calculating N control algorithms for respective controllers to correspond to N motor driving conditions, driving the motor under N motor driving environments by using at least one controller of the respective controllers, calculating performance indexes by using predetermined control factors which are detected when driving the motor using the at least one controller under the N motor driving environments, and storing the calculated N control algorithms for the respective controllers and the performance indexes corresponding to each of the N motor driving conditions.

According to an aspect of the invention, the calculating the performance indexes includes assigning predetermined weights to each of the predetermined control factors, and calculating the performance indexes by combining the predetermined control factors to which the weights are assigned.

According to an aspect of the present invention, the control factors include maximum overshoot, response delay, velocity ripple, settling time, or acceleration information.

The foregoing and/or other aspects of the present invention are achieved by providing a method of controlling a motor in a motor control system in which N controllers corresponding to N driving conditions include a base controller to be applied to each of the N driving conditions. The method includes driving the motor by applying the base controller, converting predetermined information detected by driving the motor into system performance information, comparing the system performance information with N system performance information of the respective N controllers, and driving the motor by selecting an optimum controller under the driving condition to correspond to the system performance information most similar to the detected predetermined information.

According to an aspect of the invention, the converting the predetermined information which is detected by driving the motor into the system performance information, includes assigning predetermined weights to each of the predetermined information, and calculating the system performance information by combining the predetermined information to which the weights are assigned.

According to an aspect of the invention, the detected predetermined information includes maximum overshoot, response delay, velocity ripple, settling time, or acceleration information.

The foregoing and/or other aspects of the present invention are achieved by providing a motor control method in a system driven by a motor including calculating N control algorithms for respective controllers to correspond to N motor driving conditions, driving a motor under N motor driving environments by using at least one controller of the respective controllers, calculating performance indexes by using predetermined control factors which are detected when driving the motor using the at least one controller used under the N motor driving environments. The method also includes storing the respective controllers and the performance indexes corresponding to each of the N motor driving conditions, driving the motor by applying the at least one controller, calculating a real performance index by using control results which are detected when driving the motor, comparing the real performance index with the stored performance indexes, and selecting the stored performance index similar to the real performance index, and driving the motor using the respective controller which corresponds to the selected stored performance index.

According to an aspect of the invention, the control factors include maximum overshoot, response delay, velocity ripple, settling time, or acceleration information.

According to an aspect of the invention, the calculating the performance indexes includes assigning predetermined weights to each of the control factors, and calculating the performance indexes by combining the control factors to which the weights are assigned.

According to an aspect of the invention, the calculating the real performance index includes assigning predetermined weights to each of the control results which are detected when driving the motor, and calculating the real performance index by combining the control results to which the weights are assigned.

The foregoing and/or other objects of the present invention are achieved by providing a system to drive a motor including a controller calculation unit to obtain functions of control parameters considering N driving environments and to calculate control algorithms according to the functions, and a memory to store the functions of the control parameters and the corresponding control algorithms.

According to an aspect of the invention, the control parameters include maximum overshoot, response delay, velocity ripple, settling time, or acceleration information.

According to an aspect of the invention, the performance indexes are calculated by assigning predetermined weights to each of the control factors and combining the control factors to which the weights are assigned.

### BRIEF DESCRIPTION OF THE DRAWINGS

The above and/or other aspects and advantages of the invention will become apparent and more appreciated from the following description of the preferred embodiments, taken in conjunction with the accompanying drawings of which:

FIG. 1 is a block diagram illustrating a conventional motor control system;

FIG. 2 is a flowchart of a conventional motor control algorithm;

FIG. 3 is a flowchart of another conventional motor control algorithm;

FIG. 4 is a flowchart to explain a motor control method according to the present invention;

FIG. 5 is an example of calculating performance indexes; and

FIG. 6 is an example of a performance index table storing performance indexes, operation environments, and controllers.

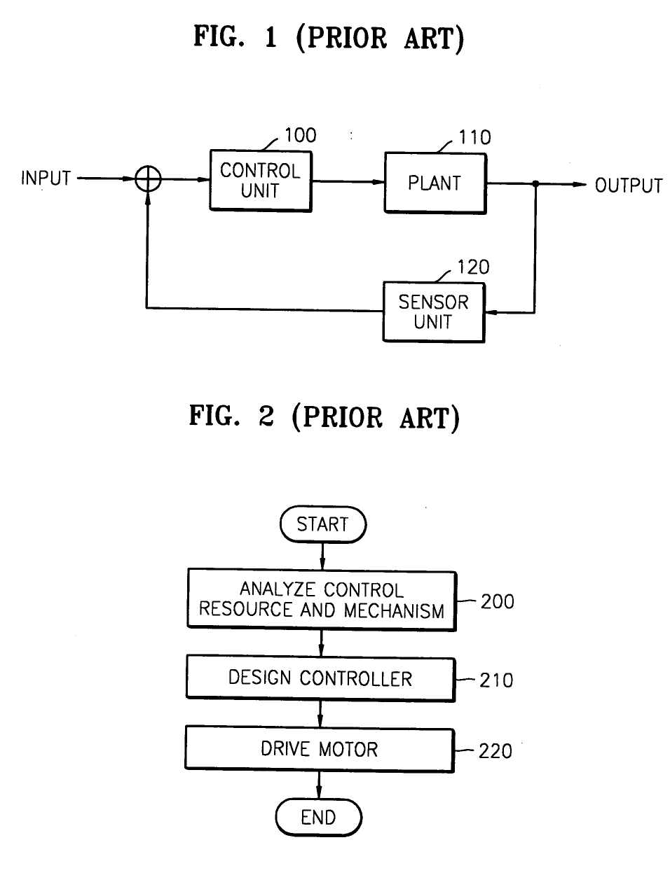

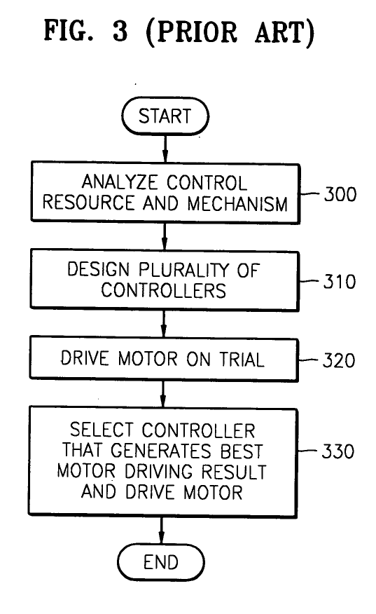

### DETAILED DESCRIPTION OF THE PREFERRED EMBODIMENT

Reference will now be made in detail to the present preferred embodiments of the present invention, examples of which are illustrated in the accompanying drawings, wherein like reference numerals refer to like elements throughout.

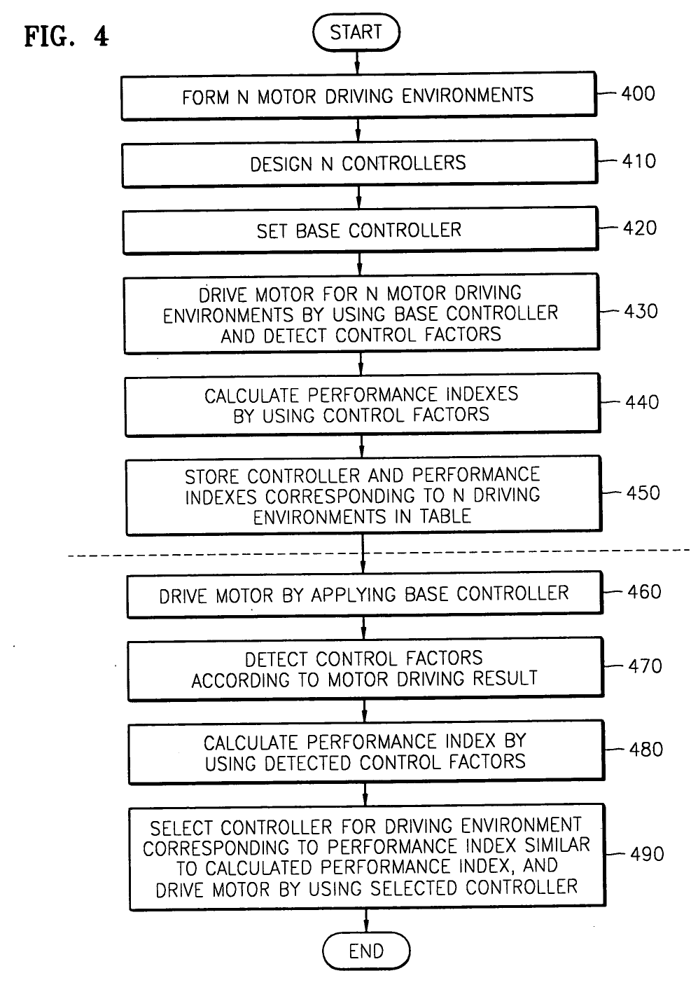

FIG. 4 is a flowchart to explain a method of controlling a motor, according to an embodiment of the present invention.

Referring to FIG. 4, predetermined environments are formed by taking into consideration changes in a motor operation environment or a load of the motor, in operation 400. Here, the predetermined environments are formed based on a clock oscillation period of a control resource, and a mechanism of a system that performs a control operation.

A plurality of controllers which correspond to each of the environments are generated in operation 410.

One of the plurality of controllers is determined as a base controller in operation 420.

The base controller is applied to all of the predetermined environments to drive the motor, and control factors x1, x2, x3, etc., which are related to the performance of a system are detected, in operation 430. Here, the control factors include acceleration information, velocity ripple, position accuracy, maximum overshoot, settling time, and response delay. In the conventional method, only acceleration information or velocity information may be obtained by using a signal obtained by using a detector such as an encoder to drive the motor, and a CPU clock. However, in the present invention, the various control factors such as the acceleration information, velocity ripple, position accuracy, maximum overshoot, settling time, and response delay may be obtained by using an encoder signal and a CPU clock signal.

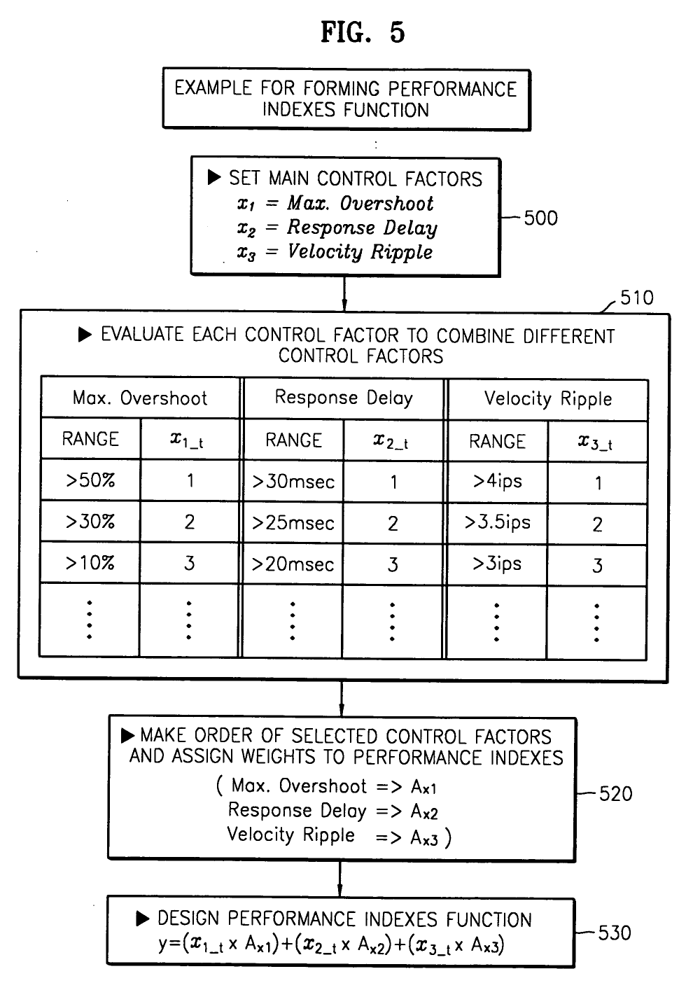

Performance indexes are calculated using the control factors in operation 440. Here, the performance indexes may be calculated as shown in FIG. 5. Referring to operation 500 of FIG. 5, the maximum overshoot, the response delay, and the velocity ripple are selected as the control factors, and are referred to as x1, x2, and x3, respectively. Predetermined weights are assigned to each of the control factors. The weights are determined by establishing predetermined reference ranges for each of the control factors, and assigning corresponding points when the control factors are included in the ranges. Operation 510 is an example of an evaluation table illustrating the control factors in order to assign the weights. For example, when a detected value of the maximum overshoot x1 is larger than 50% of a predetermined reference value, the weight of 1 is applied to the corresponding control factor. When the detected value of the maximum overshoot x1 is larger than 30% and smaller than 50% of the predetermined reference value, the weight of 2 is applied to the corresponding control factor. When the detected value of the maximum overshoot x1 is larger than 10% and smaller than 30% of the predetermined reference value, the weight of 3 is applied.

In operation 520, the order of the control factors is determined. In operation 530, the performance indexes are determined by combining the control factors according to the determined order. Here, imposing weights and combining of the control factors are only an example, and any function can be used as long as the control factors are used. The number of results formed by converting the control factors, which are obtained by applying the base controller to each driving environment, into the performance indexes appears the number of N, which corresponds to the number of the driving environments.

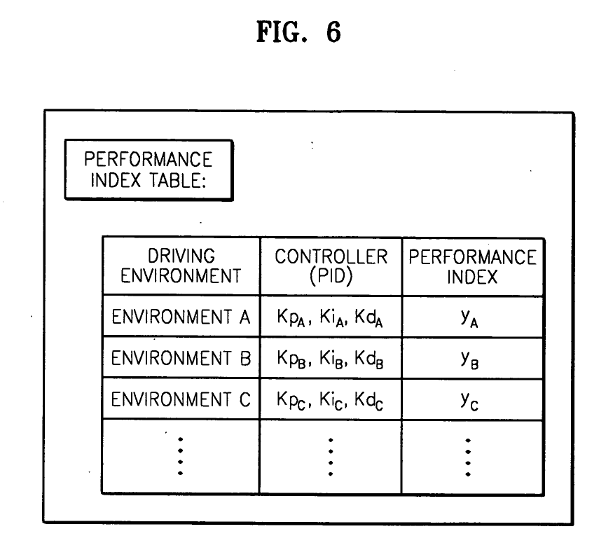

The driving environments, corresponding controllers and performance indexes are stored in a table in operation 450 of FIG. 4. In the case of using PID controllers which have different transfer functions for each driving environment, the control parameters Kpn, Kin, and Kdn of the PID controllers are stored. An example of a table which stores the performance indexes, the driving environments, and the PID controllers, is shown in FIG. 6.

The above-described processes are performed to form the motor driving control environments. The processes hereinafter are performed to select and apply the controller to drive the motor.

The motor is driven using the base controller in operation 460.

The control factors are obtained using the results that are obtained from the detector such as the encoder when driving the motor, in operation 470. Here, the control factors are the same as the control factors which are set when designing the controllers.

The performance indexes are calculated using the same method of calculating the performance indexes when designing the controllers (i.e., by using the obtained control factors), in operation 480. The calculated performance indexes and the performance indexes of each environment which are stored in the table, are compared to select the controller corresponding to the driving environment that has the most similar performance index, in operation 490.

In order to perform the method of controlling the motor, the system has to include a controller generation unit which generates the controllers to correspond to each of N driving environments, and a memory which stores the table of FIG. 6.

In the present invention, the controllers are pre-designed based on various system environments, and an optimum controller for a current motor driving environment is selected using control factors which are detected by applying one controller of the pre-designed controllers when driving the motor. Unlike the conventional method of selecting the optimum controller for the current driving environment by driving each of the controllers, the present invention detects the driving environment when designing the controllers using the control factors, and selects the controller designed according to the detected driving environment. In the present invention, since all of the controllers are not driven, the system is not wasted, and an amount of time to detect the optimum controller is reduced.

Although a few preferred embodiments of the present invention have been shown and described, it would be appreciated by those skilled in the art that changes may be made in these embodiments without departing from the principles and spirit of the invention, the scope of which is defined in the claims and their equivalents.

1. A method of controlling a motor in a motor driving system, the method comprising:
calculating N control algorithms corresponding to N motor driving conditions;
driving the motor under N motor driving environments by using one of the calculated algorithms;
calculating performance indexes by using predetermined control factors which are detected when driving the motor using the algorithm under the N motor driving environments; and
storing the calculated N control algorithms and the performance indexes corresponding to each of the N motor driving conditions.

2. The method of claim 1, wherein the calculating of the performance indexes comprises:
assigning predetermined weights to each of the predetermined control factors; and
calculating the performance indexes by combining the predetermined control factors to which the weights are assigned.

3. The method of claim 2, wherein the predetermined control factors include maximum overshoot, response delay, velocity ripple, settling time, or acceleration information.

4. A method of controlling a motor in a motor control system in which N controllers corresponding to N driving conditions include a base controller to be applied to each of the N driving conditions, the method comprising:
driving the motor by applying the base controller;
converting predetermined information detected by driving the motor into system performance information;
comparing the system performance information with N system performance information of the respective N controllers; and
driving the motor by selecting an optimum controller under the driving condition to correspond to the system performance information most similar to the detected predetermined information.

5. The method of claim 4, wherein the converting of the predetermined information detected by driving the motor into the system performance information, comprises:
assigning predetermined weights to the predetermined information; and
calculating the system performance information by combining the predetermined information to which the weights are assigned.

6. The method of claim 5, wherein the detected predetermined information includes maximum overshoot, response delay, velocity ripple, settling time, or acceleration information.

7. A motor control method in a system driven by a motor, the method comprising:
calculating N control algorithms corresponding to N motor driving conditions;
driving the motor under N motor driving environments by using one of the calculated algorithms;
calculating performance indexes by using predetermined control factors which are detected when driving the motor using the algorithm under the N motor driving environments; and
storing the calculated N control algorithms and the performance indexes corresponding to each of the N motor driving conditions;
driving the motor by applying the algorithm;
calculating a real performance index by using control results which are detected when driving the motor;
comparing the real performance index with the stored performance indexes, and selecting the stored performance index most similar to the real performance index; and
driving the motor using the algorithm which corresponds to the selected stored performance index.

8. The method of claim 7, wherein the control factors include maximum overshoot, response delay, velocity ripple, settling time, or acceleration information.

9. The method of claim 7, wherein calculating the performance indexes comprises:
assigning predetermined weights to each of the control factors; and
calculating the performance indexes by combining the control factors to which the weights are assigned.

10. The method of claim 9, wherein calculating the real performance index comprises:
assigning predetermined weights to each of the control results which are detected when driving the motor; and
calculating the real performance index by combining the control results to which the weights are assigned.

11. A system for driving a motor, the system comprising:
a controller calculation unit to obtain functions of control parameters considering N driving environments and to calculate control algorithms according to the functions; and
a memory to store the functions of the control parameters and the corresponding control algorithms.

12. The system of claim 11, wherein the control parameters include maximum overshoot, response delay, velocity ripple, settling time, or acceleration information.

13. A system for driving a motor, comprising:
a plurality of driving environments; and
a plurality of controllers pre-designed based on the driving environments, wherein at least one controller of the plurality of controllers is selected to control a specific driving environment of the driving environments using control factors.

14. The system of claim 13, wherein the control factors include position accuracy, maximum overshoot, response delay, or settling time.

15. The system of claim 14, wherein predetermined weights are assigned to each of the control factors, the weights being determined by establishing predetermined reference ranges for each of the control factors and assigning corresponding points when the control factors are included in the ranges.

16. A system for driving a motor, comprising:
a plurality of driving environments; and
a plurality of controllers pre-designed based on the driving environments, wherein less than all of the controllers is selected to control a specific driving environment of the driving environments using control factors.
